(19) United States
(12) Patent Application Publication
(10) Pub. No.: US 2015/0133833 A1
(43) Pub. Date: May 14, 2015

(54) Vibrator

(71) Applicants: Christopher Michael Bradley, Orinda, CA (US); Jeffrey Alan Tilley, La Honda, CA (US); Alan Scott Crarer, Santa Cruz, CA (US)

(72) Inventors: Christopher Michael Bradley, Orinda, CA (US); Jeffrey Alan Tilley, La Honda, CA (US); Alan Scott Crarer, Santa Cruz, CA (US)

(21) Appl. No.: 14/538,234

(22) Filed: Nov. 11, 2014

Related U.S. Application Data
(60) Provisional application No. 61/902,714, filed on Nov. 11, 2013.

(51) Int. Cl. A61H 19/00; A61H 23/00

(52) U.S. Cl. CPC A61H 19/40; A61H 23/00; A61H 2201/1671; A61H 2205/087
USPC 601/18; 601/46

(57) ABSTRACT

The present invention is directed to a vibrator using an oscillating motion and shaped tip with wings provide greater sexual stimulation, that is configured with a secure locking mechanism, that is configured not to stall the motor when pressure is applied to the tip, and which has no exposed parts and can be operated by means of a switch not likely to be accidently pressed during use, or which can be configured remotely.

### CROSS-REFERENCE TO RELATED APPLICATIONS

The present application claims the benefit of U.S. Provisional Application No. 61/902,714, filed on Nov. 11, 2013, incorporated by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to sexual self-stimulators or marital aids. More specifically, the invention is directed to a vibrator.

### BACKGROUND OF THE INVENTION

Vibrators have been used for sexual therapy, as marital aids, and for recreational sexual stimulation. U.S. Pat. No. 3,710,785 to Hilger dated Jan. 16, 1973 discloses a vibrator in which a head is vibrated and moved in an orbital path. However, this vibrator does not provide for internal stimulation, has exposed parts, is not rechargeable, is not waterproof, and does not provide oscillation.

Wand style vibrators became more popular as they provide ease of use and easier access to areas to be stimulated. U.S. Pat. No. 4,604,993 to Moriwaki at al. dated Aug. 12, 1986 discloses a wand style vibrator. The head includes a heating element, and vibrates transverse to the housing. However, this vibrator does provide for internal stimulation, has exposed parts, is not rechargeable, is not waterproof, and does not provide oscillation. U.S. Pat. No. 4,846,158 to Teranishi dated Jul. 11, 1989 discloses a wand style vibrator with a bulb. An unbalanced weight on rotary shaft creates the vibratory motion. However, this vibrator does not provide for internal stimulation, has exposed parts, is not rechargeable, is not waterproof, and does not provide oscillation. U.S. Pat. No. 4,958,628 to Iwamoto et al. dated Sep. 25, 1990 discloses a wand style vibrator with an integrated bulb. A drive motor with eccentric flyweight mounted in head creates the vibratory motion. However, this vibrator does not provide for internal stimulation, has exposed parts, and does not provide oscillation.

A more recent type of motion utilized by vibrator is oscillation. U.S. Pat. No. 5,067,480 to Woog dated Nov. 26, 1991 discloses an oscillating vibrator. This vibrator provides integrated attachments and a handle with an oscillator. However, this vibrator has exposed parts and is not waterproof.

Other vibrators have attempted to emulate oral stimulation. U.S. Pat. No. 5,470,303 to Leonard et al. dated Nov. 28, 1995 discloses a housing containing a drive with a tongue shaped head with an arcuate shaft, whereby path of shaft during rotation defines an ellipsoid with a cone on the outer free end thereof. However, this vibrator does not provide for internal stimulation and has exposed parts.

Being able to control the intensity of the vibration has become an essential element of providing enjoyable vibration. U.S. Pat. No. 6,027,444 to Franck dated Feb. 22, 2000 discloses a vibrator that has a frequency regulating device and an amplitude regulating device. However, this vibrator does not provide for internal stimulation, has exposed parts, and is not waterproof

U.S. Pat. No. 7,166,072 to Smith dated Feb. 23, 2007 discloses a bullet style vibrator with a tear shaped head with pimples. However, this vibrator does not provide for oscillation and is not waterproof. U.S. Pat. No. 7,341,566 to Nan dated Mar. 11, 2008 discloses a battery powered vibrator with a removable battery compartment. However, this vibrator does has exposed parts, does not provide for oscillation, and is not waterproof.

What is needed is a vibrator with using a motion and tip shape to provide greater sexual stimulation, that is configured with a secure locking mechanism so that the user is not worried about accidentally dislodging the tip during use, that is configured not to stall the motor when pressure is applied, and which has no exposed parts and can be operated by means of a switch not likely to be accidently pressed during use, or which can be configured remotely. What is needed is a vibrator that provides for oscillation to create vibratory motion, has no exposed parts and is waterproof, thus allowing for both external and internal stimulation. The vibrator should have a tip with flexible wings to provide maximum stimulation. The tip should securely attach to the vibrator so that the tip cannot accidentally be detached and thereby interrupt stimulation. Ideally, the motor should not stall when pressure is applied to the tip, thereby increasing the safety and longevity of the vibrator. Additionally, the vibrator should be rechargeable and provide for discreet storage.

### SUMMARY OF THE INVENTION

The present invention provides for a stimulating tips for internal and external stimulation. Tips are shaped for maximum stimulation of different body parts. There are multiple different tips that will be compatible with the device. In one embodiment of the present invention, a winged tip applies direct and powerful force to a shaped two-sided surface on the tip. This is advantageous because other vibrators will stop when it hits a surface. The tips are compliant, so they will not stop when they hit a surface.

This tip is shaped roughly as a cylinder topped with a bulb which has a scoop taken out it so that the scooped bulb forms two flexible wings protruding from solid back. The tip can be made of silicone, so that body of the tip is fairly stable and rigid as compared to the wings, which are more flexible. When oscillating motion is applied to the tip, due to the flexibility of the wings, the wings move through an angle of operation greater than the tip itself. When used for clitoral stimulation, if a 20 degree oscillating motion is applied to the tip, the flexible wings will oscillate 18.5 degrees on each side and so each flexible wing will come into contact with, and stimulate, the clitoris on each oscillation. In one embodiment of the present invention, a plurality of interchangeable tips are available to provide sexual stimulation to different parts of the body. Whereas the winged tip provides external clitoral stimulation, another tip roughly shaped as a cylinder with a solid bulb on top could be used for internal stimulation of the G-spot.

In one embodiment of the present invention, the tip is secured to the vibrator by a locking mechanism, so that the user does not have to worry about the tip coming off during use, especially when inserted into the body for internal stimulation.

This tip comprises a tip enclosure surrounded by the tip overmold, except at the base of the tip enclosure, which is open and used for locking to the vibrator. The tip enclosure is made of sufficiently hard material, such as a thermoplastic material like polycarbonate/abs. The tip enclosure has a thicker base implementing the locking mechanism, and tapers to a spire on the top half which provides structural support to the shaped tip overmold, which is made of a softer and more flexible material, preferably with a polymer like silicone, but other elastomers such as rubber can also be used. Between the tip enclosure base and tip enclosure spire, there is one or more compression channels leading to a compression cavity located in the center of the tip enclosure base. The compression cavity and compression channels are filled with the tip overmold such that the tip overmold partially fills the upper interior space of the tip enclosure base. The inner walls of the tip enclosure base have three compression nubs.

The vibrator has a quarter turn cap at the top of the wand in which the quarter turn cap has three roughly “J” shaped lock slots. To implement the locking mechanism, the base of the tip is pushed down onto the quarter turn cap and turned to the right. When the tip is pushed down, the compression nubs of the tip enclosure slide down the stem of the “J” in the lock slots on the turn cap. When the tip is turned, the compression nubs slide over to the hook portion of “J” shaped lock slot. Compression then forces the compression nubs up to the top of the hook portion of the “J” shaped lock slot, thereby securely locking the tip to the vibrator. A compression spring is required at this point to push up to hold the tip in the slot in the locked in position. Initially, a metal compression spring was integrated into the assembly to accomplish this, but it was advantageously discovered that a pass core feature could be created by injecting some of the overmold material inside the tip, thereby creating an elastomeric compression spring. This greatly simplifies the assembly as it eliminates numerous parts.

In one embodiment of the present invention, the tips have compliance built into the tip so that the motor does not overload or stall. If you hold down the shaft of a motor it will stall. Other vibrators utilizing a motor to provide motion to a tip will stall, or partially stall, if sufficient pressure is applied to the tip. Usually the durometer of these tips are harder than in the present invention. These tips usually are either a rigid plastic or an over molded elastomer that is between 50 and 90 durometer. This is an issue because it will burn out the motor if it is held in a stalled or slightly stalled position for any length of time. The present invention solves this problem by creating a system where the motor never stalls by utilizing an elastomeric tip, preferably silicone, with a durometer sufficiently low enough to allow the tip enclosure to oscillate through its full angle of operation within the silicone tip overmold, even if the tip is held stationary. Preferably, the durometer of the tip overmold is less than 35. Consequently, the elastomeric head can be stalled, such as by pressing the elastomeric tip against a surface or holding it in you hand, such that the tip overmold will stop oscillating; but the tip-enclosure will continue oscillating back and forth normally, thereby preventing the motor from becoming overloaded or stalled.

One embodiment of the present invention provides for an integrated body and tip mechanism with no exposed parts. In one embodiment of the present invention, the vibrator is provided with a smooth form factor with no jacks or plugs, and is waterproof. The body and tip have a soft covering, preferably silicone, enabling use of the entire mechanism for stimulation. In order to have no exposed parts, the vibrator needs to have a mechanism for recharging without direct electrical contacts between the vibrator and the charger, and the vibrator needs to be turned on and off and adjusted without the use of external buttons and knobs.

In one embodiment of the present invention, the vibrator is paired with an induction charger to recharge the vibrator's battery without the need for direct electrical contacts between the vibrator and the charger, such as exposed metal parts, plugs or jacks. Advantageously, the charger is provided with one or more magnets that cause the vibrator to remain securely attached to the charger without the need for a locking mechanism. This will allow the vibrator to recharge even if the vibrator is lying on its side. This is handy if the vibrator and charger get accidentally knocked over, or if the user desires to discreetly charge the vibrator in a drawer requiring the vibrator and charger to be horizontal in order to fit.

In one embodiment of the present invention, the base cap acts as the on/off and adjustment button. Locating and integrating the button on the base allows the rest of the vibrator to be used for stimulation without the danger of inadvertently turning the vibrator off or inappropriately changing an adjustment, thereby interrupting the stimulation. In one embodiment of the present invention, the base cap can be pressed once to activate or deactivate the vibrator, and other button press combinations, such as a double-press, can be utilized to control other adjustments to the vibrator, such as frequency or amplitude. In one embodiment of the present invention, the vibrator is configured to remember the user's preferred settings or adjustments. In one embodiment of the present invention, the drive train of the vibrator is configured with a wireless receiver, allowing the vibrator to be activated and adjusted using a wireless transmitter. In one embodiment of the present invention, the wireless receiver is a Bluetooth chip, and the wireless transmitter is a smartphone.

In one embodiment of the present invention, the vibrator is stored in unique packaging case that allows it to be stored unobtrusively. Additionally, the case may include cable routing so that the vibrator can be charged while stored unobtrusively in the case. Additionally, the case may have a locking mechanism which can include a combination lock or two zippers.

In one embodiment of the present invention, the vibrator and charger can be stored unobtrusively in a lamp dock. The shade of the damp dock may be opaque, thereby discreetly obscuring the fact that it is housing a vibrator. The lamp dock may also include a mood lamp for ambiance. In one embodiment of the present invention, the lamp dock may be used as a regular lamp or mood light by replacing the shade. In one embodiment of the present invention, the lamp dock can be configured with a wireless receiver and attributes of the lamp can be set with a wireless transmitter. In one embodiment of the present invention, the wireless receiver is a Bluetooth chip, and the wireless transmitter is a smartphone. In one embodiment of the present invention, the lamp dock can wirelessly coordinate lighting attributes with other lamp docks.

In accordance with the present invention, there is provided a device that provides an oscillating style of vibration where the tip oscillates back and forth to create vibration or stimulation. The entire device including the tip and the body are covered in silicone so that the device may be used to stimulate in many different ways. The device does not have any exposed plugs/jacks or metal charging components, as it uses wireless magnetic induction charging to charge the device's internal batteries. In one embodiment of the present invention, the device is completely waterproof. In one embodiment of the present invention, the charging base and the device have magnets inside which help to create a positive mating of the device and the charging base and ensures that it can be charged on its side, in a drawer or other orientation. In one embodiment of the present invention, the device has a locking tip that keeps the tip from being pulled off accidentally while being used.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front oblique view of the wand, tip, charger and lamp enclosure.

FIG. 2 is an exploded front oblique view of the wand.

FIG. 3 is a side view of the drive train.

FIG. 4 is a front view of the drive train.

FIG. 5 is a top view of the printed circuit board.

FIG. 6 is an exploded side oblique view of the drive train.

FIG. 7A is a side cross-section view of the tip overmold and tip enclosure.

FIG. 7B is a side view of the tip enclosure.

FIG. 7C is a side cross-section view of the tip enclosure.

FIG. 7D is a bottom view of the tip enclosure.

FIG. 8A is a rear view of the tip.

FIG. 8B is a top view of the tip.

FIG. 9A is a side oblique view of the turn cap.

FIG. 9B is a side cross-section view of the turn cap

FIG. 10 is a front view of the charger.

FIG. 11 is an exploded front oblique view of the charger.

FIG. 12 is a front view of the lamp enclosure.

FIG. 13 is an exploded front oblique view of the lamp enclosure.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

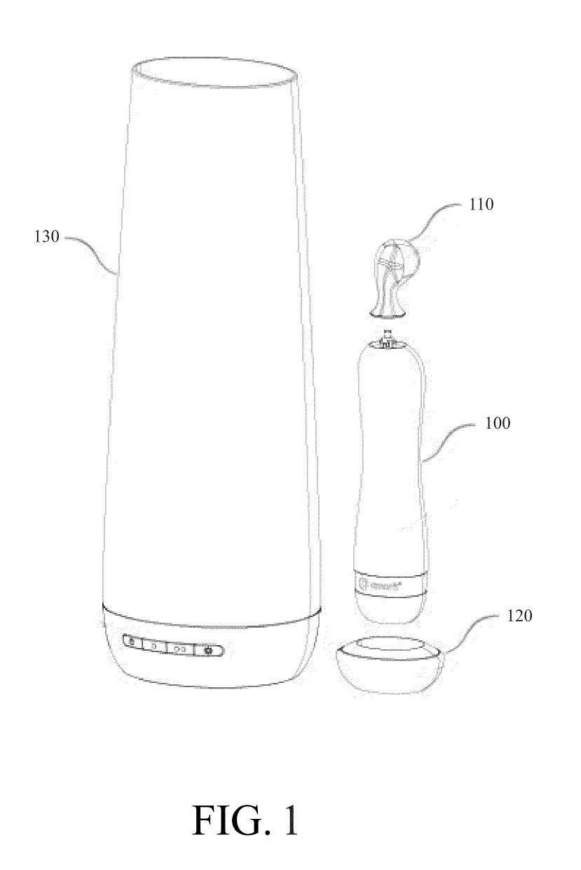

Turning now to FIG. 1, shown is a system for providing sexual stimulation comprising a wand 100, a tip 110, a charger 120, and a lamp enclosure 130. The tip 110 is configured to securely attach to the wand 110 by means of a locking mechanism. The wand 100 is recharged by the charger 120 by placing the base of the wand 100 onto the cradle body of the charger 120. When not use, the wand 100, tip 110 and charger 120 may be discreetly stored, and optionally charged, within the lamp enclosure 130.

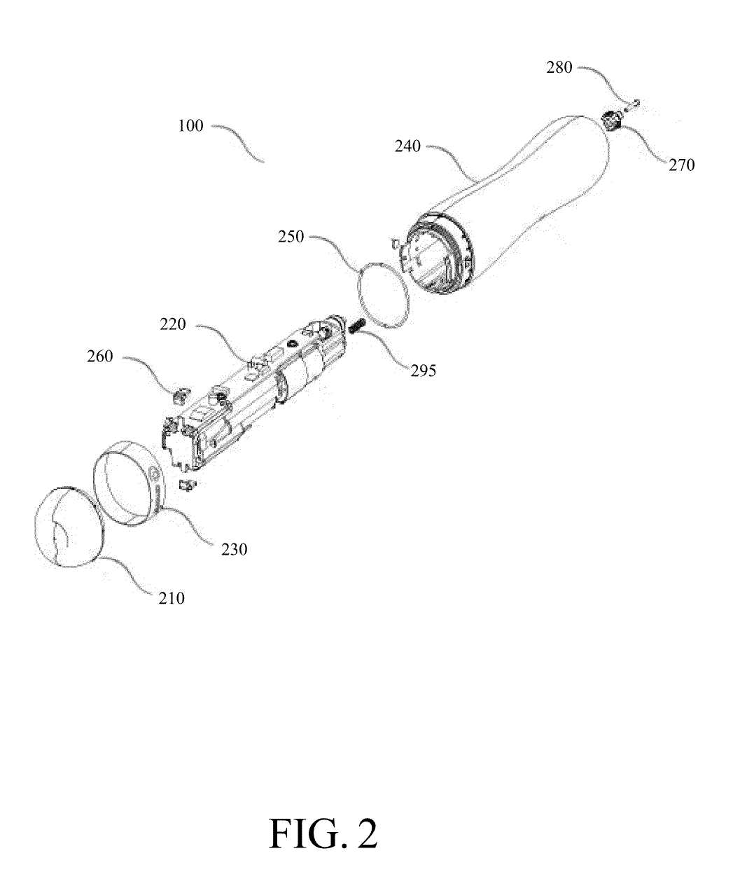

Turning now to FIG. 2 shown is an exploded front oblique view of the wand 100. The body 240 of the wand houses the drive train 220 and is secured on the bottom by the base cap 210, which may also act as the activation and adjustment button when electrically connected to the drive train 220. A beauty ring 230 providing decorative accent may also be secured to the base of the body 240 when the base cap 210 is attached. A sealing ring 250 ensures that the connection between the base cap 210 and body 240 is sealed. The drive train 220 may additionally be secured within the body with a chassis stabilizer 260. At the top of the wand 100, a turn cap 280 is secured to the drive train with a turn screw 280, and upon which compression is applied by a compression spring 295. With a tip attached to the turn cap 270, there is provided an an integrated body 240 and tip mechanism with no exposed parts. The vibrator is provided with a smooth form factor with no jacks or plugs, and is waterproof. The body 240 and tip have a soft covering, preferably silicone, enabling use of the entire mechanism for stimulation. The base cap 210 can act as the on/off and adjustment button. Locating and integrating the button on the base cap 210 allows the rest of the vibrator to be used for stimulation without the danger of inadvertently turning the vibrator off or inappropriately changing an adjustment, thereby interrupting the stimulation. For example, the base cap 210 can be pressed once to activate or deactivate the vibrator, and other button press combinations, such as a double-press, can be utilized to control other adjustments to the vibrator, such as frequency or amplitude.

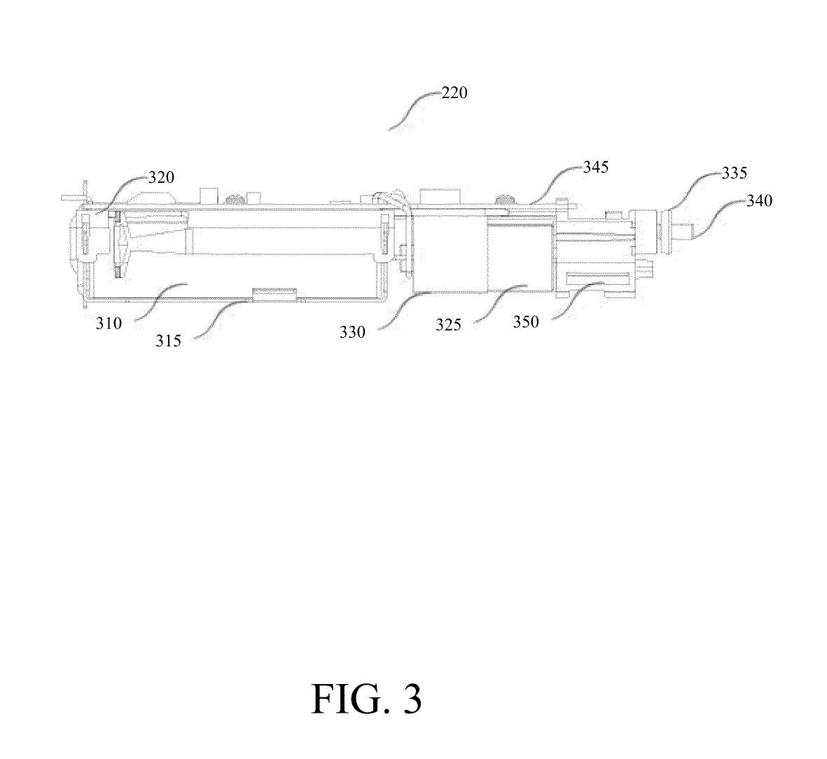

Turning now to FIG. 3 shown is a side view of the drive train 220. The drive train 220 provides the energy from the battery 310 to drive the motor 325, whose continuous spinning motion is converted to an oscillating motion by the transmission chassis 350. The chassis 315 is a mild steel frame which holds the battery 310, motor 325 and transmission chassis 350 in place. The battery 310 is additionally secured at the base by the chassis cap 320, and the motor tie 330 secures the motor 325 to the chassis 315. The printed circuit board 345 lies along the length of the drive train 220 and is fixedly attached to the chassis cap 320. The printed circuit board 345 contains electrical components responsible for activating the vibrator and controlling adjustments to the vibrators operation by, among other things, controlling the amount of current provided to the motor 325 by the battery 310. The transmission chassis 350 drives the oscillating motion of the output shaft 340. The output shaft 340 extends through the top of the body of the vibrator, but the output seal 335 ensures that the body of the wand is sealed at the top.

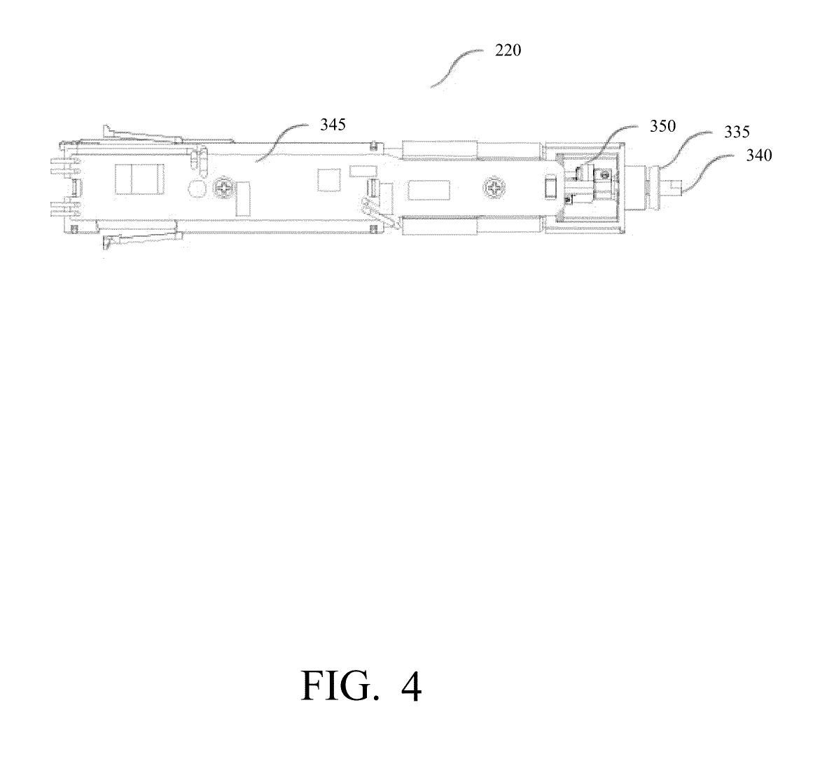

Turning now to FIG. 4, shown is a front view of the drive train 220, primarily showing the printed circuit board 345 running along the length of the drive train 220. Also shown at the top of the drive train 220 is the transmission chassis 350 connected to the output shaft 340, which is secured by the output seal 335.

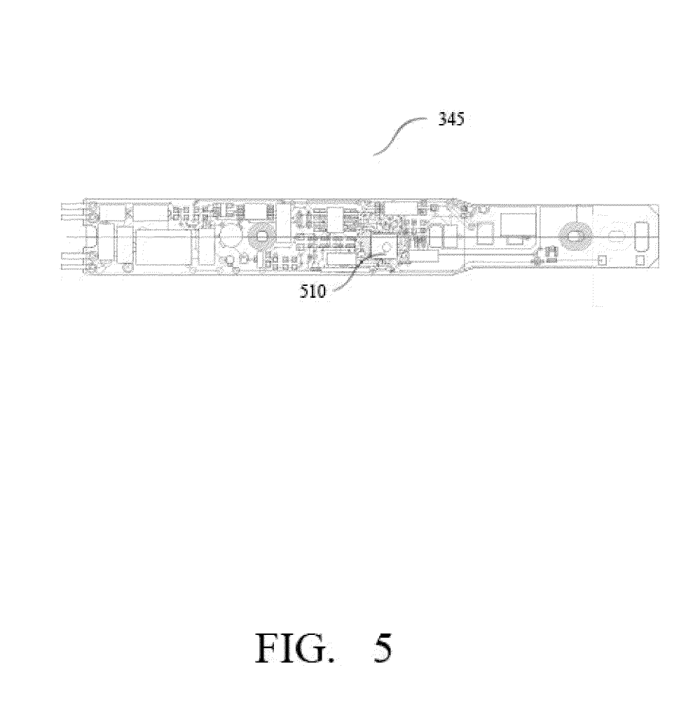

Turning now to FIG. 5, shown is a top view of the printed circuit board 345 in which can be seen the wireless receiver 510 in the form of a Bluetooth chip. The printed circuit board 345 is electrically connected to the drive train, allowing the vibrator to be activated and adjusted using a wireless transmitter, such as a smartphone. The vibrator can be configured to remember the user's preferred settings or adjustments.

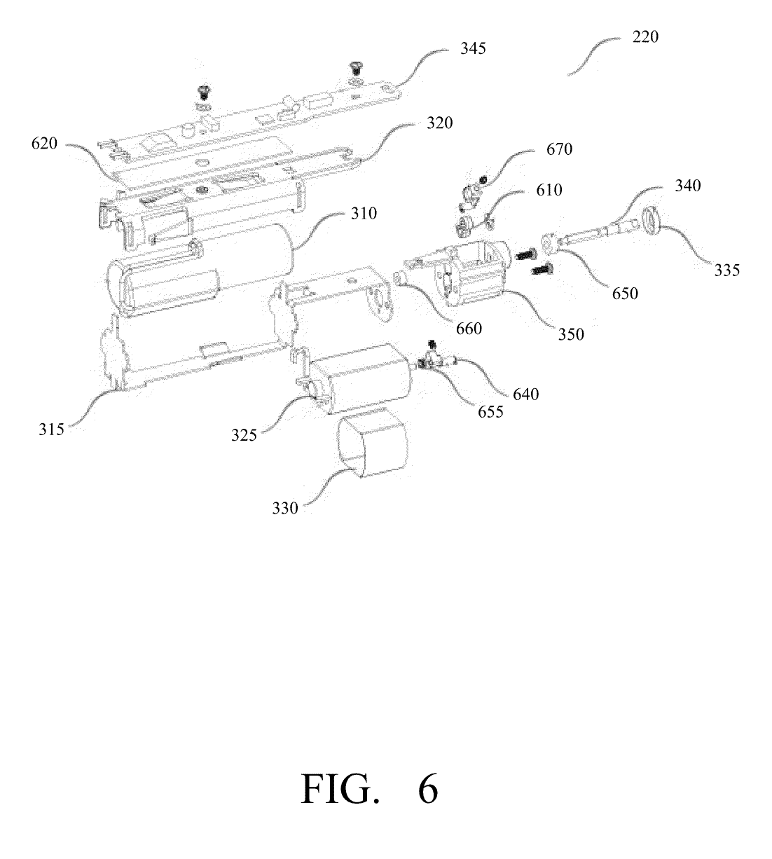

Turning now to FIG. 6, shown is an exploded side oblique view of the drive train 220. The chassis 315 holds the battery 310 at the base portion of the drive train 220. The battery 310 is further secured by the chassis cap 320, which connects to the chassis 315 on the bottom, and on the top the chassis cap 320 is connected to the printed circuit board 345, with a small intervening piece of pcb foam 620 protecting the printed circuit board 345. The top portion of the chassis 315 holds the motor 325, which is further secured to the chassis 315 by the motor tie 330. The transmission chassis 350 is fixedly attached to the top of the chassis 315, and through a opening in the top of the chassis 315, the transmission chassis 350 is connected to the motor 325 by the motor extension 640 through a bearing 660 and secured by the motor extension spring 655. The transmission chassis 350 is connected to the proximal end of the output shaft 240 through a second bearing 650 and internally connected to the output base 650 secured by output spring 610. The output shaft extends through the output seal 335 on the distal end.

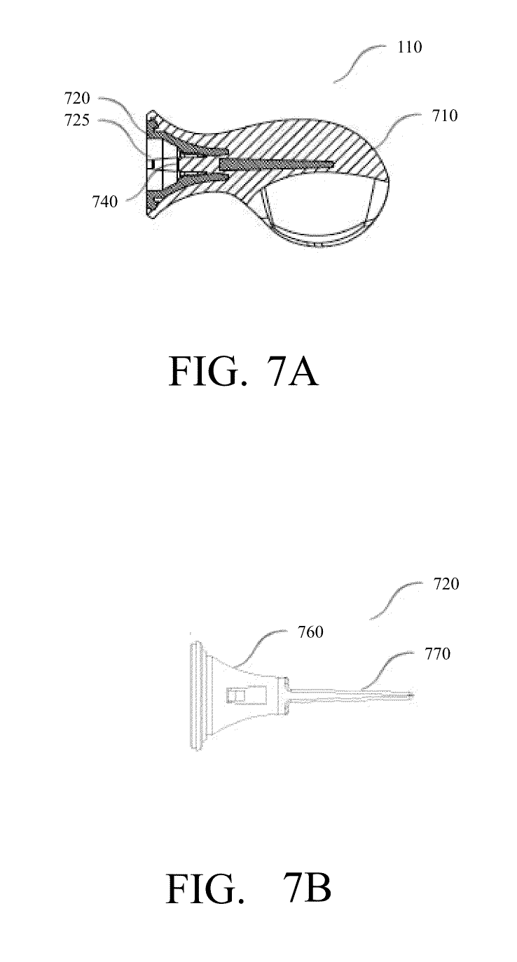

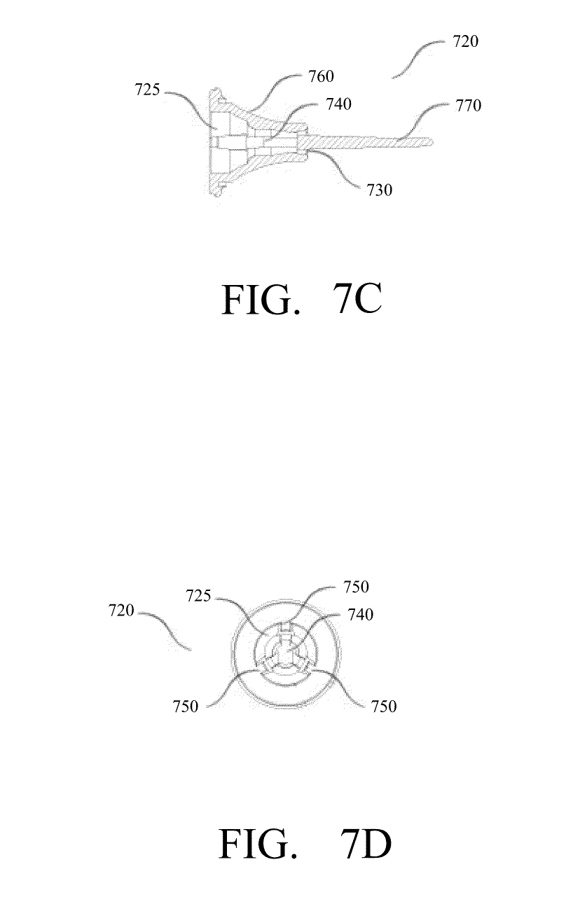

Turning now to FIG. 7A, shown is a side cross-section view of a tip 110, including the tip overmold 710 and tip enclosure 720. Additionally, the turn cap cavity 725 and compression cavity 740 can be seen. The tip enclosure 720 is secured to the vibrator by a locking mechanism, so that the user does not have to worry about the tip coming off during use, especially when inserted into the body for internal stimulation. The tip enclosure 720 is surrounded by the tip overmold 710, except at the base of the tip enclosure 720, which has an open turn cap cavity 725 configured to accept a turn cap and used for locking to the vibrator. The tip overmold 710 is made of a softer and more flexible material than the tip enclosure 720, preferably with a polymer like silicone, but other elastomers such as rubber can also be used.

Additionally, the tip 110 has compliance built in so that the motor of the vibrator does not overload or stall. The motor of the vibrator does not stall because the overmold 710 is elastomeric, preferably silicone, with a durometer sufficiently low enough to allow the tip enclosure 720 to oscillate through its full angle of operation within the silicone tip overmold 710, even if the tip 110 is restrained. Preferably, the durometer of the tip overmold 710 is less than 35. With such a durometer, the elastomeric tip 110 can be stalled, such as by pressing the elastomeric tip 110 against a surface or holding it in your hand, such that the tip overmold 710 will stop oscillating; but the tip-enclosure 720 will continue oscillating back and forth normally, thereby preventing the motor from becoming overloaded or stalled.

Turning now to FIG. 7B, shown is a side view of the tip enclosure 720 comprising the tip enclosure base 760 and the tip enclosure spire 770. The tip enclosure 720 is made of sufficiently hard material, such as a thermoplastic material like polycarbonate/abs, to provide support to the tip overmold and secure to the turn cap. The tip enclosure 720 has a thicker tip enclosure base 760 implementing the locking mechanism, and tapers to a tip enclosure spire 770 on the top half which provides structural support to the shaped tip overmold.

Turning now to FIG. 7C, shown is a side cross-section view of the tip enclosure 720, comprising the tip enclosure base 760 and tip enclosure spire 770. Between the tip enclosure base 760 and tip enclosure spire 770 are one or more compression channels 730 which lead to the compression cavity 740. The compression cavity 740 and compression channels 730 are filled with the tip overmold such that the tip overmold partially fills the upper interior space of the tip enclosure base 760.

Turning now to FIG. 7D, shown is a bottom view of the tip enclosure 720 in which can be seen the turn cap cavity 725 for receiving the turn cap. In the center of the turn cap cavity 725, the bottom of the compression cavity 740 can be seen. On the interior wall of the turn cap cavity 725 are three compression nubs 750. The tip is secured to a turn cap by applying downward pressure on the tip such that the compression nubs 750 slide down the groove in the turn cap, and when rotated and released, the flexible material of the overmold in the compression cavity 740 exerts pressure on the top of the turn cap, causing the compression nubs 750 to secure themselves in the lock slots of the turn cap.

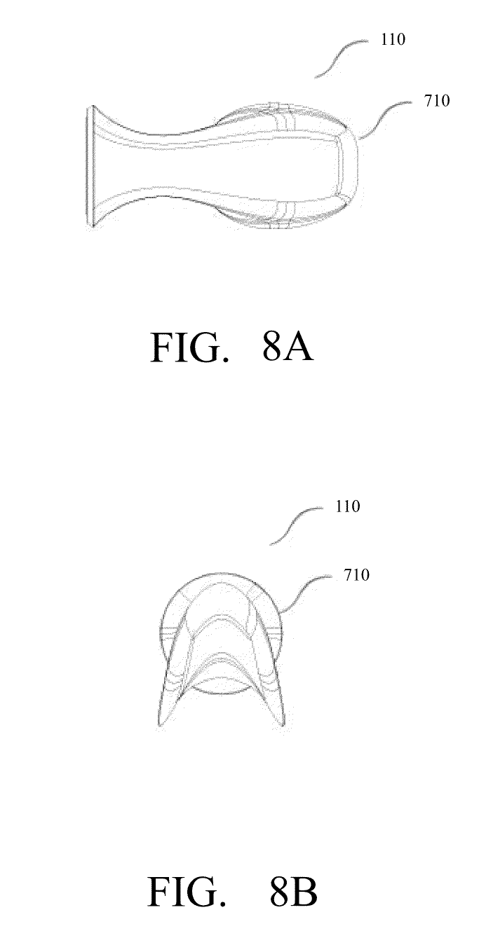

Turning now to FIG. 8A, shown is a rear view of the tip 110, primarily showing the tip overmold 710. Turning now to FIG. 8B, shown is a top view of the tip 100, primarily showing the tip overmold 710 in which the flexible wings can be seen extending from the back of the tip overmold 710. This winged tip can apply direct and powerful force to the wings. This is advantageous because other vibrators will stop when it hits a surface. The wings are compliant, made of a soft durometer of less then 35, so they will not stop when they hit a surface. As can be seen, this tip is shaped roughly as a cylinder topped with a bulb which has a scoop taken out it so that the scooped bulb forms two flexible wings protruding from solid back. The tip can be made of silicone, so that body of the tip is fairly stable and rigid as compared to the wings, which are more flexible. When oscillating motion is applied to the tip, due to the flexibility of the wings, the wings move through an angle of operation greater than the tip itself. For example, if a 20 degree oscillating motion is applied to the tip, the flexible wings will oscillate significantly beyond the 20 degree angle of operation.

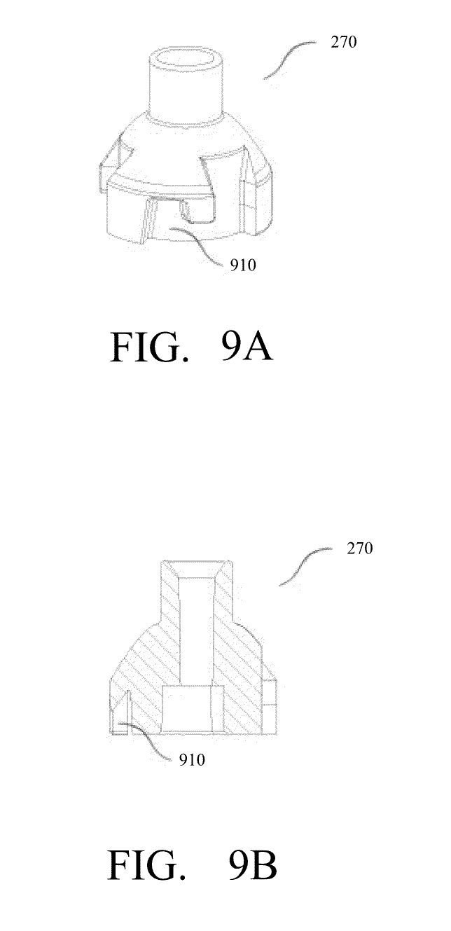

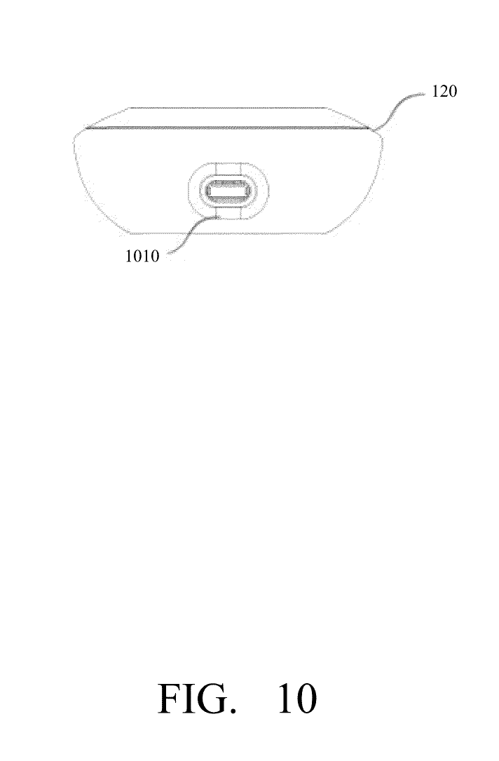

Turning now to FIG. 9A, shown is a side oblique view of the turn cap 270 in which the lock slot 910 can be seen. The turn cap 270 is a quarter turn cap that mounts on the top of the wand of the vibrator. The turn cap 270 has three roughly “J” shaped lock slots 910. To implement the locking mechanism, the base of the tip is pushed down onto the turn cap 270 and turned to the right. When the tip is pushed down, the compression nubs of the tip enclosure slide down the stem of the “J” in the lock slots 910 on the turn cap 270. When the tip is turned, the compression nubs slide over to the hook portion of “J” shaped lock slot 910. Compression then forces the compression nubs up to the top of the hook portion of the “J” shaped lock slot 910, thereby securely locking the tip to the vibrator. Turning now to FIG. 9B, shown is a side cross-section view of the turn cap 270.

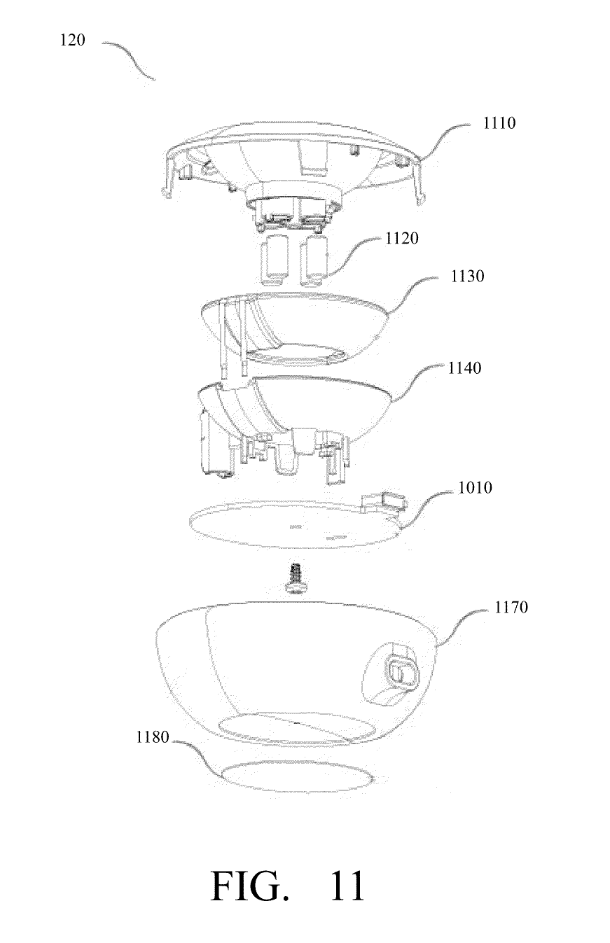

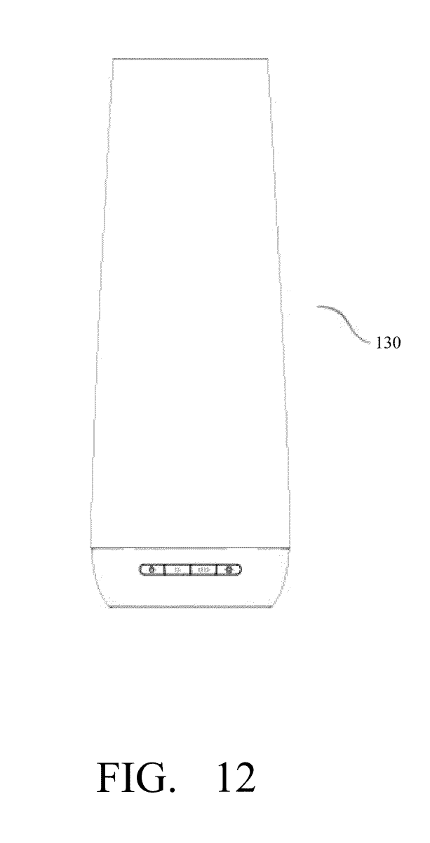

Turning now to FIG. 10, shown is a front view of the charger 120 showing the connection to the charger printed circuit board 1010. In order to have no exposed parts, the vibrator needs to have a mechanism for recharging without direct electrical contacts between the vibrator and the charger 120, and the vibrator needs to be turned on and off and adjusted without the use of external buttons and knobs. Turning now to FIG. 11, shown is an exploded front oblique view of the charger 120. The top of the cradle cap 1110 at the top of the charger 120 has an indentation that is configured to accept the bottom of a vibrator for charging. The bottom of the cradle cap 1110 is configured to hold one or more magnets 1120, which are used to secure the vibrator to the charger while charging. Nested below the cradle cap 1110 are the coil 1130 and the coil keeper 1140, which in turn is connected to the charger printed circuit board 1010. The cradle cap 1110 is connected to the cradle body 1170 by a locking mechanism, thereby securely housing the coil 1130, coil keeper 1140, charger printed circuit board 1010, and magnets. The charger 120 may optionally have an information label 1180 adhesively attached to the bottom of the cradle body 1170.

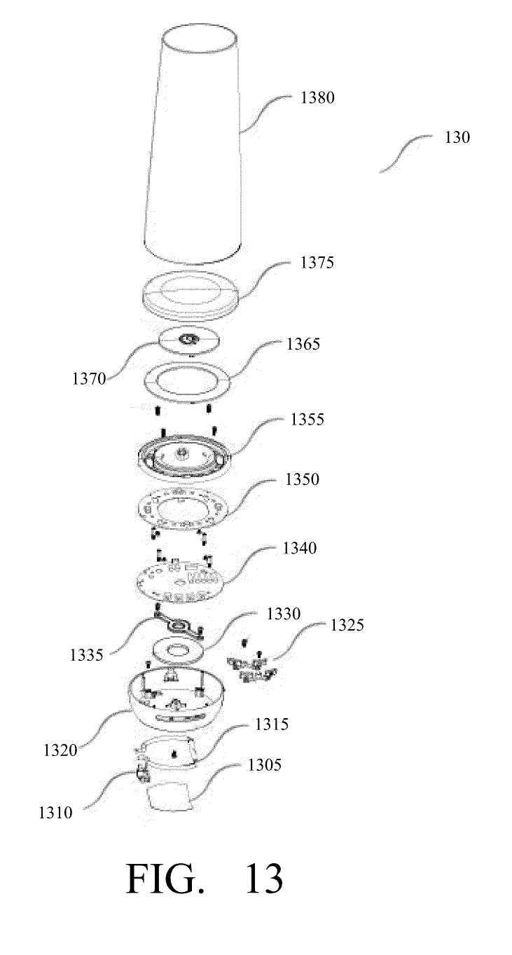

FIG. 12 shows a front view of the lamp enclosure 130. Turning now to FIG. 13, shown is an exploded front oblique view of the lamp enclosure 130. At the bottom of the lamp enclosure 130 is the base 1320. Optionally, under the base 1320 is stand 1315 that can be used to position the direction of the light coming from the lamp enclosure 130 and a label 1305 that can be adhesively attached to the bottom of the base 1320. Light strips 1325 may be positioned in an opening of the base 1320 to provide user interface information to the user. A washer 1330 and 1335 ballast strap help secure the lower printed circuit board 1340 and upper printed circuit board 1350. A cap 1355 is fixedly attached to the 1320, thereby securely housing the lower printed circuit board 1340, upper printed circuit board 1350, and light strips 1325. A lens 1365 is mounted on the top of the cap 1355. Depending on the intended use, a tall shade 1380 may be placed on the cap 1355 over the lens 1365, and the lamp enclosure 130 can be used as a discreet storage unit for the vibrator and charger. The charger with vibrator attached can be place on top of the lens 1365 for storage and charging, and the tall shade 1380, preferably made from a semi-opaque translucent material, will obscure the presence of the vibrator and charger. Optionally, the lamp enclosure 130 may be used as a traditional lamp by planting a plug 1370 over the indentation into which the charger rests, and replacing the tall shade 1380 with a short shade 1375. The vibrator and charger can be stored unobtrusively in the lamp dock 130. Additionally, the lamp dock 130 can be configured with a wireless receiver and attributes of the lamp can be set with a wireless transmitter such as a smartphone. Additionally, the lamp dock 130 can wirelessly coordinate lighting attributes with other lamp docks.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A vibrator comprising:
a. means for inducing rotational oscillation through an angle of operation;
b. a tip with flexible wings wherein said flexible wings move through an angle of operation greater than said inducing means;
c. means for attaching said tip to said inducing means.

2. The vibrator of claim 1 wherein said angle of operation of said rotational oscillation is about 20 degrees.

3. The vibrator of claim 1 wherein said flexible wings oscillate through an angle of operation of about 37 degrees.

4. The vibrator of claim 1 wherein said tip is made of silicone.

5. The vibrator of claim 1 wherein said tip has a durometer of less than 35.

6. The vibrator of claim 1 wherein said tip can be detached from said inducing means.

7. A vibrator comprising:
a. means for inducing rotational oscillation through an angle of operation;
b. a tip comprising a tip enclosure and a tip overmold;
c. wherein said tip enclosure is made of rigid material with a turn cap cavity at the base configured to receive a turn cap fixedly attached to said inducing means;
d. wherein the interior wall of said turn cap cavity has a plurality of compression nubs protruding from said interior wall;
e. wherein said tip overmold is made of a less rigid material than said tip enclosure and surrounds the sides and top of said tip enclosure;
f. wherein at least one compression channel comprises a channel to a compression cavity located above said turn cap cavity, wherein said overmold fills said compression channel and said compression cavity;
g. whereby when pressure is applied to said tip directed down on said turn cap, said compression nubs slide down the grooves of said turn cap, and when said tip is turned and said pressure is released, said overmold in said compression cavity exerts pressure on said turn cap, thereby securing said compression nubs in the lock slots of said turn cap.

8. The vibrator of claim 7 wherein said tip enclosure is made of thermoplastic.

9. The vibrator of claim 7 wherein said tip overmold is made of an polymer.

10. The vibrator of claim 7 wherein said tip overmold is made of an elastomer.

11. A vibrator comprising:
a. means for inducing rotational oscillation through an angle of operation, wherein said means include a motor;
b. a tip comprising a tip enclosure and a tip overmold, wherein said tip enclosure is made of rigid material and said tip overmold is made of a less rigid material and surrounds the sides and top of said tip enclosure;
c. means for attaching said tip to said inducing means;
d. whereby said tip enclosure will oscillate within said tip overmold if said overmold is restrained, thereby preventing undue wear on, or stall of, said motor.

12. The vibrator of claim 6 wherein said tip enclosure is made of thermoplastic.

13. The vibrator of claim 6 wherein said tip overmold is made of an polymer.

14. The vibrator of claim 6 wherein said tip overmold is made of an elastomer.

15. A vibrator comprising:
a. a wand comprising
i. a body;
ii. a drive train situated inside of said body comprising
1. a battery;
2. a controller electrically connected to said battery;
3. a motor electrically connected to said controller;
4. a wireless receiver connected to said controller;
iii. an output shaft wherein the proximal end is connected to said drive train and the distal end protrudes through the top of said body;
b. a tip connected to the distal end of said output shaft;
c. wherein the motion of said tip can be controlled by sending wireless signals to said wireless receiver.

16. The vibrator of claim 15 wherein said body and said tip are sealed in silicone.

17. The vibrator of claim 15 wherein said drive train is hermetically sealed in said body.

18. The vibrator of claim 15, wherein said vibrator is waterproof

19. The vibrator of claim 15, wherein there are no external protuberances such that the vibrator can by used for internal stimulation.

20. The vibrator of claim 15, wherein said battery is rechargeable.

21. The vibrator of claim 15, further comprising a charger.

22. The vibrator of claim 21, wherein said charger further comprises an induction coil for charging said battery without direct contact.

23. The vibrator of claim 15 wherein said charger further comprises magnets to secure said base of said vibrator to said charger.

24. The vibrator of claim 15, wherein the frequency of vibration is adjustable.

25. The vibrator of claim 15, wherein the amplitude of vibration is adjustable.

26. The vibrator of claim 15, wherein said vibrator has no external buttons for power or adjustments.

27. The vibrator of claim 15, wherein said wireless receiver uses the Bluetooth protocol.

28. The vibrator of claim 15, wherein power and adjustments can be communicated to said wireless receiver.

29. The vibrator of claim 15, further comprising a discreet storage enclosure.

30. The vibrator of claim 29, wherein said enclosure is a lamp.

31. The vibrator of claim 30, wherein said enclosure is a mood lamp.
